(19) United States
(12) Patent Application Publication
(10) Pub. No.: US 2026/0207011 A1
(43) Pub. Date: Jul. 23, 2026

(54) POT LID RACK

(71) Applicant: MARIA JOLANDA GALASSI, TORONTO (CA)

(72) Inventor: MARIA JOLANDA GALASSI, TORONTO (CA)

(21) Appl. No.: 19/157,350

(22) PCT Filed: Feb. 20, 2024
(86) PCT No.: PCT/CA2024/050205

§ 371 Date: Aug. 16, 2025

Related U.S. Application Data
(60) Provisional application No. 63/447,617, filed on Feb. 22, 2023.

(51) Int. Cl. A47J 47/16; A47B 81/00

(52) U.S. Cl. CPC A47J 47/16; A47B 81/00

(57) ABSTRACT

A pot lid rack for a pull-out drawer, comprising: an elongate, open-top, trapezoidal channel having first and second flanges formed along respective first and second longitudinal top edges thereof; and, a plurality of lateral slots formed in the channel, the slots extending across a bottom of the channel and at least partially up each side of the channel, the slots having widths sized to receive pot lids of varying heights edgewise; wherein respective bottom surfaces of the first and second flanges are configured to engage respective first and second top edges of first and second sides of the drawer when the pot lid rack is inserted into the drawer therebetween to support the pot lid rack and to thereby suspend edges of the pot lids above a bottom of the drawer.

This application claims priority from and the benefit of the filing date of U.S. Provisional Patent Application No. 63/447,617, filed Feb. 22, 2023, and the entire content of such application is incorporated herein by reference.

### FIELD OF THE APPLICATION

This application relates to the field of kitchen cookware storage and organization, and more specifically, to a rack or holder for pot lids, pot covers, and the like.

### BACKGROUND

Existing pot lid racks and holders fit into two main categories: free-standing horizontal racks, usually made of metal; and, hanging, generally triangular shaped, racks designed to fit over a door or be hung on a wall. While they accomplish the main function of holding pot lids, existing pot lid racks and holders have several disadvantages. One problem relates to their stability. Present pot lid racks tend to wobble when one inserts or removes a lid and may even tip over. Another problem relates to their size. Present pot lid racks have storage slots that are typically not big enough to accommodate pot lid handles. This often results in displacing the lids next to the lid one is trying to remove, even making them fall out, because the handle of one pot lid is generally stuck under the lid next to it. This also contributes to problematic wobbling and displacement of the pot lid rack.

A need therefore exists for an improved rack or holder for pot lids and the like. Accordingly, a solution that addresses, at least in part, the above and other shortcomings is desired.

### SUMMARY OF THE APPLICATION

According to one aspect of the application, there is provided a pot lid rack for a pull-out drawer, comprising: an elongate, open-top, trapezoidal channel having first and second flanges formed along respective first and second longitudinal top edges thereof; and, a plurality of lateral slots formed in the channel, the slots extending across a bottom of the channel and at least partially up each side of the channel, the slots having widths sized to receive pot lids of varying heights edgewise; wherein respective bottom surfaces of the first and second flanges are configured to engage respective first and second top edges of first and second sides of the drawer when the pot lid rack is inserted into the drawer therebetween to support the pot lid rack and to thereby suspend edges of the pot lids above a bottom of the drawer.

### BRIEF DESCRIPTION OF THE DRAWINGS

Features and advantages of the embodiments of the present application will become apparent from the following detailed description, taken in combination with the appended drawings, in which:

FIG. 1 is a front perspective view illustrating a pot lid rack in accordance with an embodiment of the application;

FIG. 2 is a front view thereof, the rear view being substantially a mirror image thereof;

FIG. 3 is right side view thereof, the left side view being substantially a mirror image thereof;

FIG. 4 is a top view thereof;

FIG. 5 is a bottom view thereof;

FIG. 6 is a top perspective view illustrating the pot lid rack of FIG. 1 installed in a pull-out drawer in accordance with an embodiment of the application; and,

FIG. 7 is a top perspective detail view illustrating the pot lid rack of FIG. 1 with pot lids inserted in ones of the pot lid slots thereof in accordance with an embodiment of the application.

It will be noted that throughout the appended drawings, like features are identified by like reference numerals.

### DETAILED DESCRIPTION OF THE EMBODIMENTS

In the following description, details are set forth to provide an understanding of the application. In some instances, certain structures, techniques and methods have not been described or shown in detail in order not to obscure the application.

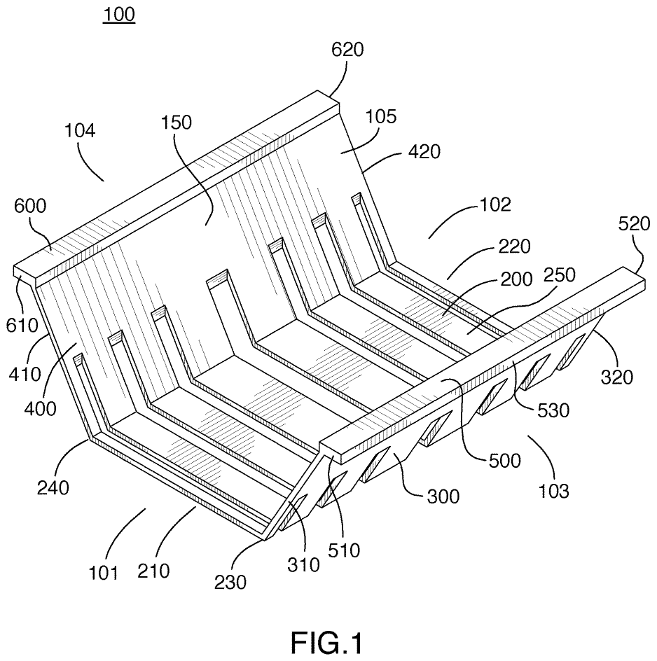

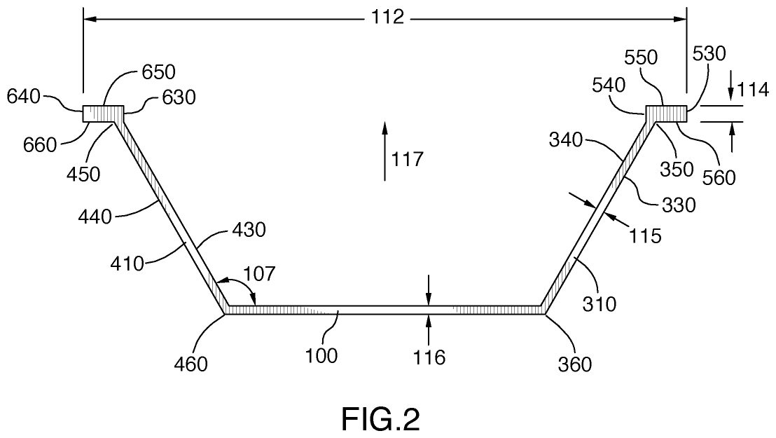

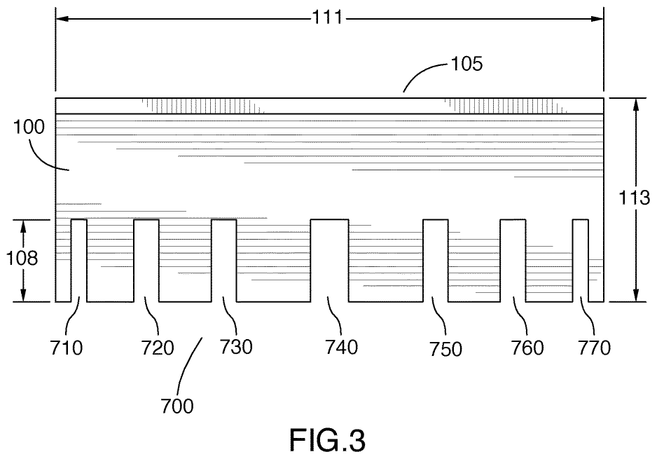

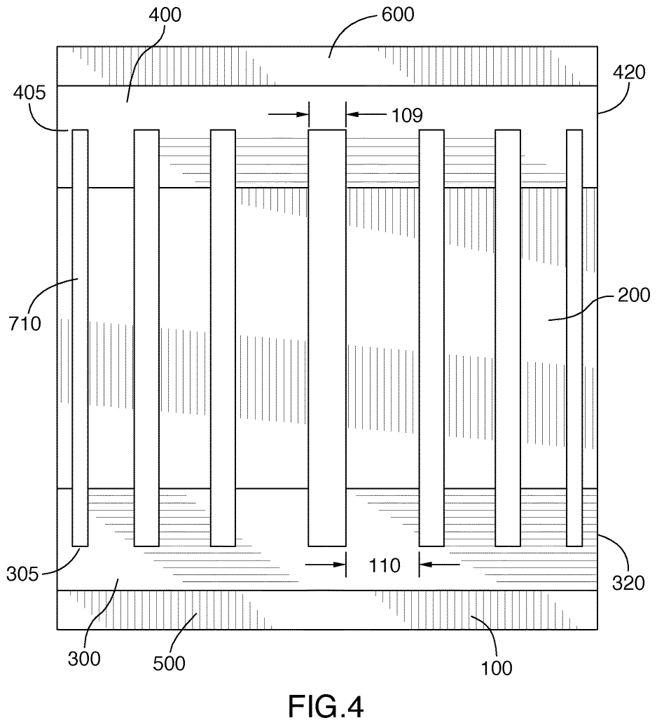

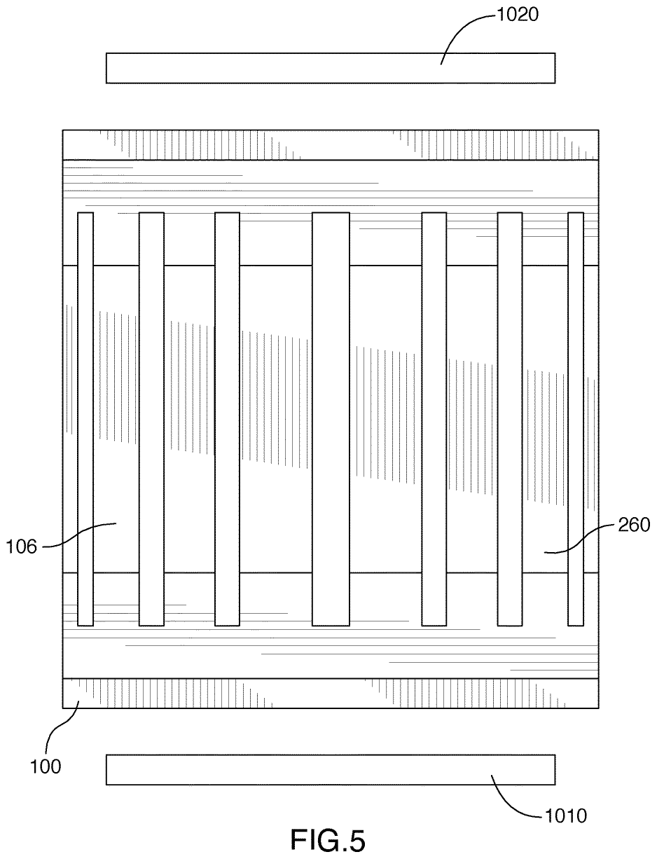

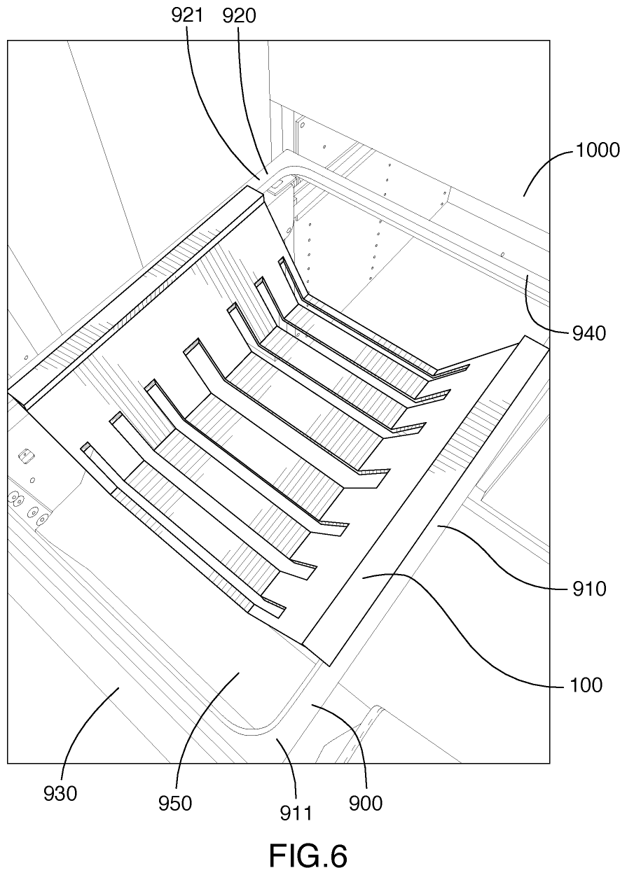

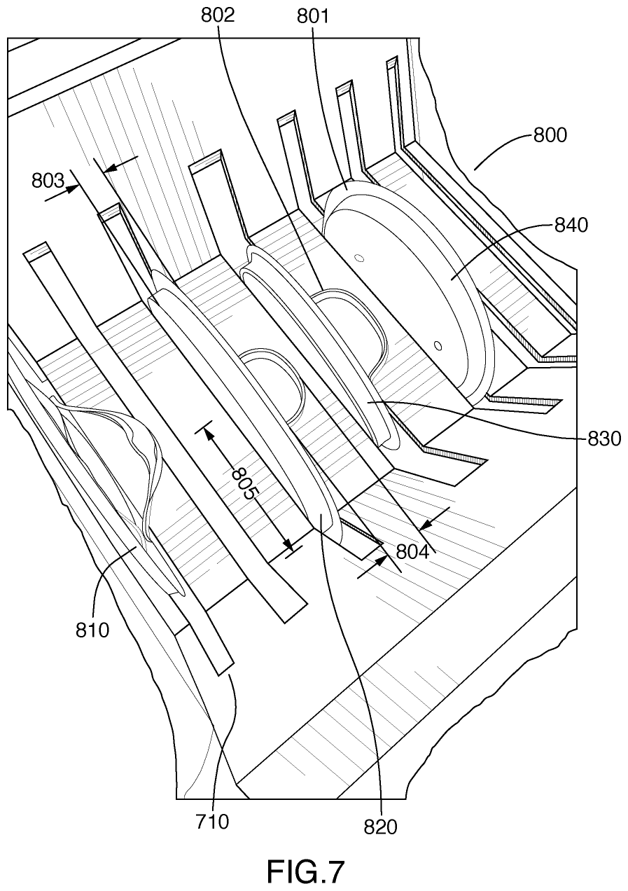

FIG. 1 is a front perspective view illustrating a pot lid rack (or holder) 100 in accordance with an embodiment of the application. FIG. 2 is a front view thereof, the rear view being substantially a mirror image thereof. FIG. 3 is right side view thereof, the left side view being substantially a mirror image thereof. FIG. 4 is a top view thereof. FIG. 5 is a bottom view thereof. FIG. 6 is a top perspective view illustrating the pot lid rack 100 of FIG. 1 installed in a pull-out drawer 900 in accordance with an embodiment of the application. And, FIG. 7 is a top perspective detail view illustrating the pot lid holder 100 of FIG. 1 with pot lids 800 (e.g., 810, 820, 830, 840) inserted into ones of the pot lid slots 700 (e.g., 710, 720, 730, 740, 750, 760, 770) thereof in accordance with an embodiment of the application.

According to one embodiment of the application, a pot lid rack 100 is provided. The pot lid rack 100 is typically mounted or installed in a pull-out or slide-out drawer 900 of a kitchen cabinet 1000 or the like. Advantageously, the pot lid rack 100 may be used to store and organize one or more pot lids 800 and the like as further described below. The pot lids 800 may be used for covering pots (not shown), pans, and other cookware used for cooking, etc.

According to one embodiment, the pot lid rack 100 is elongate, having an open-top trapezoidal trough or channel shape (i.e., in cross-section), and having a front end 101, a rear end 102, a first (or right) side 103, a second (or left) side 104, a top (or top surface or inner surface) 105 for facing away from a bottom (or bottom panel or bottom board) 950 of a drawer 900 when the pot lid rack 100 is installed therein, and a bottom (or bottom surface or outer surface) 106 for facing toward the bottom 950 of the drawer 900 when the pot lid rack 100 is installed therein. In addition, the pot lid rack 100 has a length 111, a width 112, a height 113, a flange (or handle) thickness 114, a side wall thickness 115, and a bottom portion thickness 116.

According to one embodiment, the pot lid rack 100 includes a bottom portion 200 attached (e.g., connected, bonded, coupled, joined, formed with, molded to, etc.) to two inclined (or sloped) and spaced side wall portions 300, 400 which are in turn attached to respective parallel and spaced flange (or handle) portions 500, 600 as further described below.

The bottom portion 200 of the pot lid rack 100 includes: a front side, end, edge, or wall 210; a rear side, end, edge, or wall 220; a first (or right) side, end, edge, or wall 230; a second (or left) side, end, edge, or wall 240; a top side or surface 250; and, a bottom side or surface 260.

The first and second (or right and left) side wall portions 300, 400 of the pot lid rack 100 each respectively include: a front side, end, edge, or wall 310, 410; a rear side, end, edge, or wall 320, 420; a first (or right) side, wall, or surface 330, 430; a second (or left) side, wall, or surface 340, 440; a top side, end, edge, or surface 350, 450; and, a bottom side, end, edge, or surface 360, 460.

The first and second (or right and left) flange (or handle) portions 500, 600 of the pot lid rack 100 each respectively include: a front side, end, edge, or wall 510, 610; a rear side, end, edge, or wall 520, 620; a first (or right) side, end, edge, or wall 530, 630; a second (or left) side, end, edge, or wall 540, 640; a top side, end, or surface 550, 650; and, a bottom side, end, or surface 560, 660.

According to one embodiment, the bottom ends 360, 460 of the first and second side wall portions 300, 400 are attached (e.g., connected, bonded, coupled, joined, formed with, molded to, etc.) to the top surface 250 of the bottom portion 200 along respective sides 230, 240 thereof. In addition, the top ends 350, 450 of the first and second side wall portions 300, 400 are attached (e.g., connected, bonded, coupled, joined, formed with, molded to, etc.) to respective bottom surfaces 560, 660 of the flange portions 500, 600 along respective sides 540, 630 thereof. Thus, the side wall portions 300, 400 and bottom portion 200 form an elongate, open-top, trapezoidal-shaped channel or channel portion 150 having flanges 500, 600 extending outwardly (i.e., to the right 103 and left 104) at the top end 350, 450 of each side wall portion 300, 400.

According to another embodiment, the pot lid rack 100 may be formed, pressed, or molded in one piece (e.g., from one piece of material, etc.). For example, the pot lid rack 100 may be made of plastic via an injection molding or 3-D printing process. As another example, the pot lid rack 100 may be formed from a flat sheet of metal (e.g., aluminium, stainless steel, etc.) that may be folded (or bent, formed, molded, worked, stamped, cut, etc.) into the configuration of the pot lid rack 100. Of course, the pot lid rack 100 may be made of other materials such as wood, silicone, stiff cardboard or other compostable materials, etc.

According to one embodiment, each side wall portion 300, 400 is inclined and extends upwardly from the top surface 250 of the bottom portion 200 at an angle (i.e., an obtuse angle) 107 with respect to a vertical axis 117 of the pot lid rack 100.

The channel portion 150 has a plurality of pot lid slots or slots 700 (e.g., 710, 720, 730, 740, 750, 760, 770) formed therein for receiving the edges or rims 801 of respective pot lids 800 (e.g., 810, 820, 830, 840) to secure or hold the pot lids 800 in the pot lid rack 100. The slots 700 extend laterally from proximate the right side 103 to proximate the left side 104 of the pot lid rack 100 and are positioned longitudinally from proximate the front end 101 to proximate the rear end 102 of the pot lid rack 100. Each slot (e.g., 710) may be open-top, trapezoidal channel-shaped extending from a first point 305 (at a slot height 108 above the top surface 250 of the bottom portion 200) on the first side wall portion 300 vertically down and across the bottom portion 200 and vertically up the second side wall portion 400 to a second point 405 (also at the slot height 108 above the top surface 250 of the bottom portion 200) thereon.

According to one embodiment, a slot width 109 of each slot 710 may vary between slots 700 to accommodate pot lids 800 having varying heights (or sizes) 803. Similarly, a longitudinal slot spacing 110 between slots 700 may vary to accommodate pot lids 800 having varying handle heights (or sizes) 804. The top surface 250 of the bottom portion 200 between pot lid slots 700 may provide extra support for pot lids 800 when inserted into the pot lid slots 700 by providing extra or extended points of contact between the handles 802 of the pot lids 800 and the pot lid rack 100.

The flange portions 500, 600 extend outward (i.e., to the right 103 and left 104 of the pot lid rack 100) horizontally (or approximately horizontally) from the respective side wall portions 300, 400 and are for extending over and resting their respective bottom surfaces 360, 460 on respective top edges (or ends or surfaces) 911, 921 of the side walls 910, 920 of a drawer 900 between the front and back walls 930, 940 of the drawer 900 when installed. In this way, the side walls 910, 920 of the drawer 900 support the pot lid rack 100 above the bottom 950 of the drawer 900. The bottom surface 260 of the bottom portion 200 of the pot lid rack 100 is thus suspended over the bottom 950 of the drawer 900 allowing for the edges (or rims) 801 of pot lids 800 to extend through the pot lid slots 700 formed in the bottom portion 200 without contacting the bottom 950 of the drawer 900. When inserted into the pot lid slots 700, approximately half of each pot lid 800 (i.e., the radius 805 or half of the diameter) will extend below the bottom surface 260 of the bottom portion 200 of the pot lid holder 100. In addition, the height 113 of the pot lid rack 100 is selected such that the edges or rims 801 of the pot lids 800 do not extend above the top surfaces 550, 560 of the flanges 500, 600 of the pot lid rack 100 which could prevent the drawer 900 from closing properly. The first and second side wall portions 300, 400, being inclined 107, may provide extra support for pot lids 800 when inserted into the pot lid slots 700 by providing extra or extended points of contact between the pot lids 800 and the pot lid rack 100.

Advantageously, the space defined between the bottom 106 of the pot lid rack 100 and the bottom 950 of the drawer 900 may be used for storing additional items in the drawer 900 below the pot lid rack 100.

According to another embodiment, the pot lid rack 100 may be inserted into the drawer 900 sideways, that is, it may be mounted between the front and back walls 930, 940 of the drawer 900.

According to one embodiment, the pot lid rack 100 may be fastened or attached to the side walls 910, 920 of the drawer 900 using appropriate fasteners (e.g., clips, screws, etc.) to maintain the pot lid rack 100 in place.

According to one embodiment, the pot lid rack 100 may optionally include first and second drawer slides 1010, 1020 attached to, for example, respective bottom surfaces 560, 660 of the first and second flanges 500, 600. The drawer slides 1010, 1020 may be bottom mount or side mount drawer slides. In particular, the slide portions of the drawer slides 1010, 1020 may be attached to the pot lid holder 100 and the rail portions of the drawer slides 1010, 1020 may be attached to the inner walls of the cabinet 1000. In this configuration, the pot lid rack 100 may function as a drawer 900.

According to one embodiment, the pot lid rack 100 has a length 111 of 37 cm (or approximately 37 cm), a width 112 of 25 cm (or approximately 25 cm), a height 113 of 12 cm (or approximately 12 cm), a flange (or handle) thickness 114 of 1.0 cm (or approximately 1.0 cm), a side wall thickness 115 of 0.5 cm (or approximately 0.5 cm), and a bottom portion thickness 116 of 0.5 cm (or approximately 0.5 cm). The angle 107 of incline of the side walls 300, 400 may be 120 degrees (or approximately 120 degrees), the slot height 108 may be 6 cm (or approximately 6 cm), the slot width 109 may range from 1 cm (or approximately 1 cm) to 3 cm (or approximately 3 cm), and the slot spacing 110 between slots 700 may range from 3 cm (or approximately 3 cm) to 5 cm (or approximately 5 cm). Of course, these dimensions may vary and may be sized to match the drawer 900 into which the pot lid rack 100 is to be installed and the sizes of pot lids 800 to be stored in the pot lid rack 100. Similarly, the thicknesses of one or more of the flange portions 500, 600, side wall portions 300, 400, and bottom portion 200 may be adjusted to handle the weight of the pot lids 800 that are expected to be installed in the pot lid rack 100 and on the material of which the pot lid rack 100 is made.

In operation, the pot lid rack 100 is installed in a drawer 900 by opening the drawer 900 and placing the flange portions 500, 600 of the rack 100 over the top edges 911, 921, of the side walls 910, 920 of the drawer 900 between the front and back walls 930, 940 of the drawer 900. Pot lids 800 may then be inserted edgewise (or sideways) into the pot lid slots 700 of the pot lid rack 100. The drawer 900 may then be closed to store the pot lids 800.

Thus, according to one embodiment, there is provided a pot lid rack 100 for a pull-out drawer 900, comprising: an elongate, open-top, trapezoidal channel 150 having first and second flanges 500, 600 formed along respective first and second longitudinal top edges 350, 450 thereof; and, a plurality of lateral slots 700 formed in the channel 150, the slots 700 extending across a bottom 200 of the channel 150 and at least partially up 108 each side 300, 400 of the channel 150, the slots 700 having widths 109 sized to receive pot lids 800 of varying heights 803 edgewise 801 (or sideways or rim or edge 801 first); wherein respective bottom surfaces 560, 660 of the first and second flanges 500, 600 are configured to engage respective first and second top edges 911, 921 of first and second sides 910, 920 of the drawer 900 when the pot lid rack 100 is inserted into the drawer 900 therebetween to support the pot lid rack 100 and to thereby suspend edges (or rims) 801 of the pot lids 800 above a bottom 950 of the drawer 900.

The above embodiments may contribute to an improved pot lid rack 100 and may provide one or more advantages. First, the rack 100, when inserted into a drawer 900 as described above, is very stable, and allows for lids 800 to be inserted and removed without moving the rack 100 and without touching each other. Second, the rack 100 overcomes the problems, namely size and stability related problems, of the prior art. Third, by fitting inside a drawer 900, the rack 100 saves counter and wall space normally used for currently existing racks, as well as making more efficient use of the drawer space itself, that is, by being suspended halfway (for example), the bottom of the drawer 900 underneath the rack 100 remains usable space, provided the drawer 900 is deep enough (which is not the case with existing racks which sit on the bottom of the drawer 900). Fourth, the suspended pot lid rack 100, being made to fit inside a kitchen drawer 900, allows for lids 800 to be held more securely than pot lid holders currently on the market, and also allows for a more efficient use of storage space. The design and material used to make the pot lid holder 100 makes the pot lid holder 100 more pleasing to the eye than current wire metal holders.

The embodiments of the application described above are intended to be exemplary only. Those skilled in this art will understand that various modifications of detail may be made to these embodiments, all of which come within the scope of the application.

What is claimed is:

1. A pot lid rack for a pull-out drawer, comprising:
an elongate, open-top, trapezoidal channel having first and second flanges formed along respective first and second longitudinal top edges thereof; and,
a plurality of lateral slots formed in the channel, the slots extending across a bottom of the channel and at least partially up each side of the channel, the slots having widths sized to receive pot lids of varying heights edgewise;
wherein respective bottom surfaces of the first and second flanges are configured to engage respective first and second top edges of first and second sides of the drawer when the pot lid rack is inserted into the drawer therebetween to support the pot lid rack and to thereby suspend edges of the pot lids above a bottom of the drawer.

2. The pot lid rack to claim 1, wherein a longitudinal spacing between lateral slots is sized to receive and support pot lids of varying handle sizes or heights.

3. The pot lid rack of claim 1, wherein the pot lid rack is made of one of plastic, resin, or silicone.

4. The pot lid rack of claim 1, wherein the pot lid rack is made of metal.

5. The pot lid rack of claim 4, wherein the metal is one of aluminium or stainless steel.

6. The pot lid rack of claim 1, wherein the pot lid is made of one of wood, cardboard, or a compostable material.

7. The pot lid rack of claim 1, wherein the port lid rack is formed, molded, or stamped from one piece of material.

8. The pot lid rack of claim 1, wherein the first and second flanges extend horizontally outward from the first and second longitudinal top edges of the channel.

9. The pot lid rack of claim 1, wherein the pull-out drawer is a kitchen cabinet pull-out drawer.

10. The pot lid rack of claim 1, wherein the first and second flanges are first and second handles.

11. The pot lid rack of claim 1, wherein the pot lids include lids and covers for pots, pans, and cookware.

12. The pot lid rack of claim 1, wherein the first and second top edges of the first and second sides of the drawer are first and second top edges of first and second drawer slides.

13. The pot lid rack of claim 12, wherein the first and second drawer slides are one or bottom mount and side mount drawer slides.

14. The pot lid rack of claim 1, further comprising first and second drawer slides attached to the respective bottom surfaces of the first and second flanges.
